(19) United States
(12) Patent Application Publication
(10) Pub. No.: US 2017/0194690 A1
(43) Pub. Date: Jul. 6, 2017

(54) ANTENNA DEVICE

(71) Applicant: Cheng Uei Precision Industry Co., Ltd., New Taipei City (TW)

(72) Inventors: Kuo Wei Chang, New Taipei City (TW); Wen Bing Hsu, New Taipei City (TW)

(21) Appl. No.: 14/986,989

(22) Filed: Jan. 4, 2016

(51) Int. Cl. H01Q 1/24

(52) U.S. Cl. CPC H01Q 1/24

(57) ABSTRACT

An antenna device applied in a headset device, includes a circuit board, an antenna body and a metal cover. The circuit board includes a flexible circuit board. The antenna body is mounted to the circuit board and electrically connected with the flexible circuit board. The metal cover covers and adjacent to the antenna body and the circuit board. The antenna body is coupled with the metal cover to motivate each other to make the antenna body and the metal cover respectively become a first radiating element and a second radiating element so as to reach a radiating purpose. So a better radiating effect of the antenna device is realized.

### BACKGROUND OF THE INVENTION

1. Field of the Invention

The present invention relates to an antenna, and more particularly to an antenna device applied in a headset device.

2. The Related Art

In a prior art, a headset device generally includes a plastic cover, and an antenna device assembled to the plastic cover. Performance indexes of the antenna device are listed in a table shown in FIG. 5. When the antenna device works at a frequency of 2400 MHz, the maximum gain of the antenna device is 1.21 dBi, an efficiency of the antenna device is 28.18%, and an average gain of the antenna device is −5.50 dBi. When the antenna device works at a frequency of 2450 MHz, the maximum gain of the antenna device is 1.18 dBi, the efficiency of the antenna device is 28.99%, and the average gain of the antenna device is −5.38. When the antenna device works at a frequency of 2500 MHz, the maximum gain of the antenna device is 0.44 dBi, the efficiency of the antenna device is 24.92%, and the average gain of the antenna device is −6.03 dBi.

Currently, performance requirements of the headset device are requested higher and higher by a consumer. Not only does a function of the headset device need to be improved, but also a texture of the antenna device needs to be improved. In order to improve the texture of the headset device, a metal cover is applied in the headset device. So that, the headset device has a better appearance.

However, the metal cover has a larger area, when electromagnetic waves encounter the metal cover, electromagnetic waves will be reflected by the metal cover that will affect transmissions of the electromagnetic waves, if the metal cover is cut into pieces to reach a better radiating effect, the pieces of the metal cover need be integrally molded that will increase a manufacturing cost.

In view of the above-mentioned problems, an innovative antenna device is essential to be provided, the innovative antenna device is applied in a headset device with a metal cover and capable of effectively receiving and sending the electromagnetic signals.

### SUMMARY OF THE INVENTION

An object of the present invention is to provide an antenna device applied in a headset device. The antenna device includes a circuit board, an antenna body and a metal cover. The circuit board includes a flexible circuit board. The antenna body is mounted to and electrically connected with the flexible circuit board. The metal cover covers and adjacent to the antenna body and the circuit board. The antenna body is coupled with the metal cover to motivate each other to make the antenna body and the metal cover respectively become a first radiating element and a second radiating element.

As described above, the circuit board includes the flexible circuit board, and the metal cover covers and adjacent to the antenna body and the circuit board, the antenna body is coupled with the metal cover to motivate each other to make the antenna body and the metal cover respectively become the first radiating element and the second radiating element so as to reach a radiating purpose. As a result, a better radiating effect of the antenna device is realized without cutting the metal cover to decrease a manufacturing cost.

### BRIEF DESCRIPTION OF THE DRAWINGS

The present invention will be apparent to those skilled in the art by reading the following description, with reference to the attached drawings, in which:

FIG. 1 is a perspective view showing that an antenna device in accordance with the present invention is applied in a headset device;

FIG. 2 is a partially perspective view of the antenna device showing an antenna body and a circuit board of the antenna device of FIG. 1;

FIG. 3 is a perspective view showing that the antenna device is applied in the headset device of FIG. 1, wherein a metal cover is removed;

FIG. 4 is a table which lists performance indexes of the antenna device in accordance with the present invention; and

FIG. 5 is a table which lists performance indexes of an antenna device in a prior art.

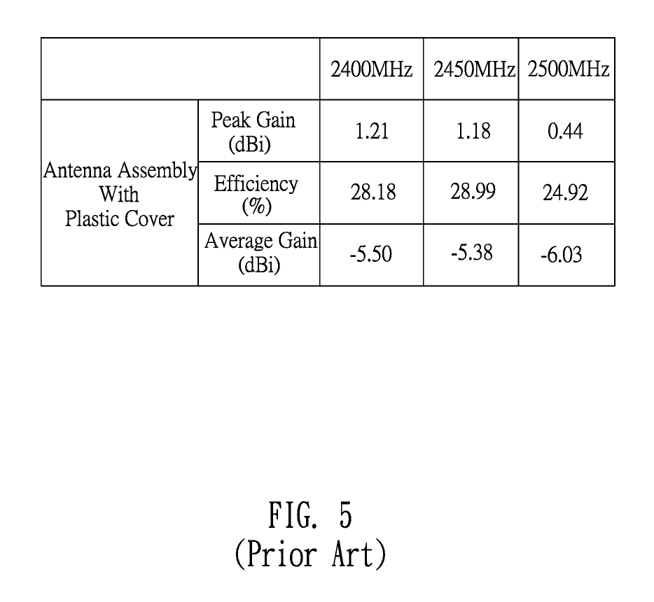

### DETAILED DESCRIPTION OF THE PREFERRED EMBODIMENT

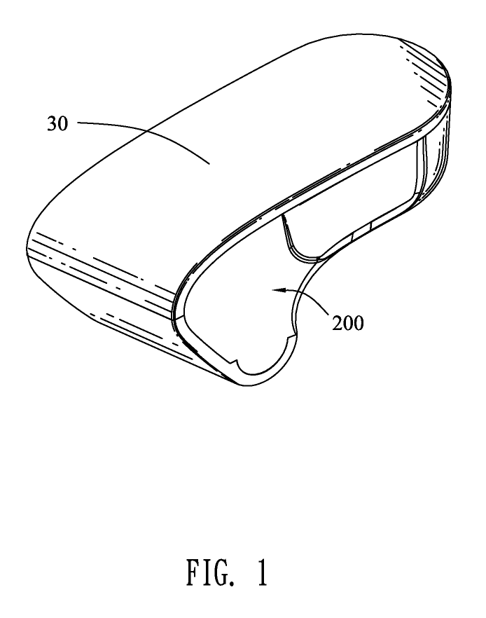

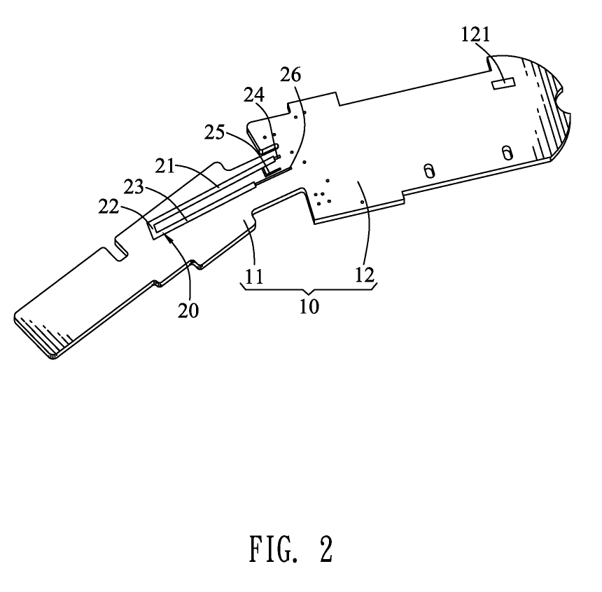

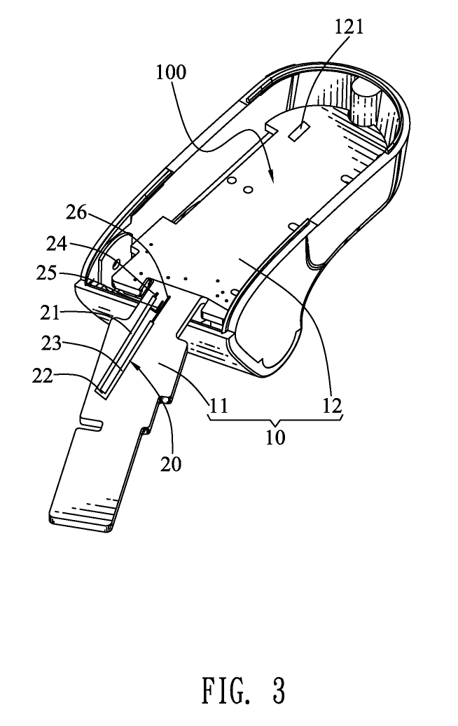

Referring to FIG. 1 to FIG. 3, an antenna device 100 in accordance with the present invention is shown. The antenna device 100 is applied in a headset device 200. The antenna device 100 in accordance with the present invention includes a circuit board 10, an antenna body 20 and a metal cover 30. The metal cover 30 is an outer cover portion of the headset device 200. The headset device 200 is a Bluetooth headset.

The circuit board 10 includes a flexible circuit board 11 and a rigid circuit board 12 electrically connected with the flexible circuit board 11. A front end of the flexible circuit board 11 is connected to a rear end of the rigid circuit board 12. The flexible circuit board 11 is folded over the rigid circuit board 12 when the antenna device 100 is assembled completely. The circuit board 10 has an antenna circuit (not shown) and a ground circuit (not shown). The flexible circuit board 11 has the antenna circuit. The rigid circuit board 12 has the ground circuit.

The antenna body 20 is mounted to and electrically connected with the flexible circuit board 11 of the circuit board 10. Specifically, the rigid circuit board 12 has a ground portion 121. The antenna body 20 is a PIFA (Planar Inverted F-Antenna) type antenna or a loop type antenna. A material of the flexible circuit board 11 is copper, iron, gold, silver, stainless steel, a copper-nickel-zinc alloy, a copper nickel alloy, nickel silver copper, nickel, a piano wire, aluminum or any conductive metal.

The metal cover 30 covers and adjacent to the antenna body 20 and the circuit board 10. The antenna body 20 is coupled with the metal cover 30 to motivate each other to make the antenna body 20 and the metal cover 30 respectively become a first radiating element and a second radiating element so as to reach a radiating purpose. A distance between the antenna body 20 and the metal cover 30 is within 4 mm to reach a better radiating effect.

The antenna body 20 is a monopole antenna. The antenna body 20 has a long strip-shaped first section 21, a short strip-shaped second section 22, a long strip-shaped third section 23 substantially parallel with the first section 21, and a feeding section 24. The first section 21 and the third section 23 extend substantially in a front-to-rear direction, the second section 22 is connected with rear ends of the first section 21 and the third section 23. The feeding section 24 is connected with a front end of the first section 21.

Preferably, the antenna body 20 is the PIFA type antenna, the antenna body 20 has the long strip-shaped first section 21, the short strip-shaped second section 22, the long strip-shaped third section 23 substantially parallel with the first section 21, the feeding section 24 and a fourth section 25. The first section 21 and the third section 23 extend substantially in the front-to-rear direction, the second section 22 is connected with the rear ends of the first section 21 and the third section 23. The feeding section 24 is connected with the front end of the first section 21. The fourth section 25 is extended perpendicularly and towards the third section 23 from a portion of the first section 21 adjacent to the front end of the first section 21, and then perpendicularly bent frontward, the fourth section 25 is electrically connected with the ground portion 121 of the rigid circuit board 12.

Preferably, the antenna body 20 is the loop type antenna, the antenna body 20 has the long strip-shaped first section 21, the short strip-shaped second section 22, the long strip-shaped third section 23 substantially parallel with the first section 21, the feeding section 24 and a fifth section 26. The first section 21 and the third section 23 extend substantially in the front-to-rear direction, the second section 22 is connected with the rear ends of the first section 21 and the third section 23. The feeding section 24 is connected with the front end of the first section 21. A front end of the third section 23 extends frontward to the rigid circuit board 12 to form the fifth section 26. The fifth section 26 is electrically connected with the ground portion 121 of the rigid circuit board 12.

The first radiating element is coupled with the second radiating element to receive and send the electromagnetic wave signals. Specifically, a radiating frequency band of the first radiating element and the second radiating element is ranged between 2400 MHz and 2500 MHz. The first radiating element and the second radiating element resonate at a frequency range covering 2400 MHz to 2500 MHz to receive and send the electromagnetic wave signals corresponding to a frequency band ranged between 2400 MHz and 2500 MHz. So that the antenna device 100 applied in the headset device 200 is capable of effectively receiving and sending the electromagnetic wave signals.

Referring to FIG. 1 to FIG. 3, in use, the antenna device 100 is applied in the headset device 200, a front end of the feeding section 24 is electrically connected with the antenna circuit of the flexible circuit board 11. The ground portion 121 is electrically connected with the ground circuit of the rigid circuit board 12. The metal cover 30 is integrally formed.

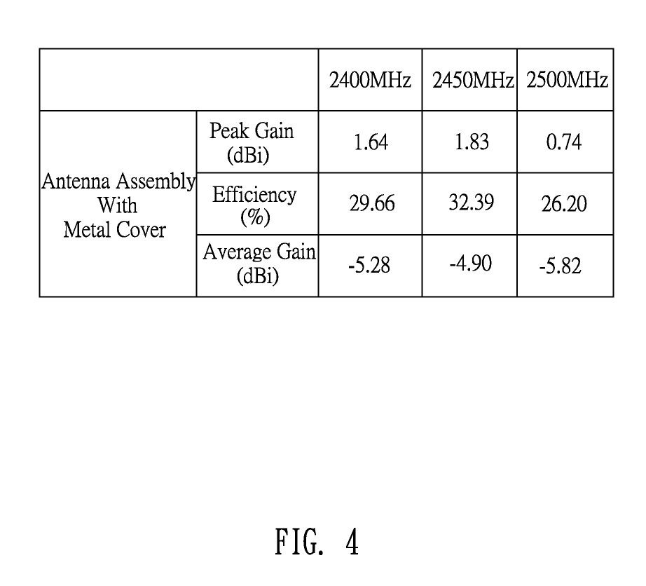

Referring to FIG. 1 to FIG. 4, performance indexes of the antenna device 100 in accordance with the present invention are listed in a table shown in FIG. 4. When the antenna device 100 works at a frequency of 2400 MHz, the peak gain of the antenna device 100 is 1.64 dBi, an efficiency of the antenna device 100 is 29.66%, and an average gain of the antenna device 100 is −5.28 dBi. When the antenna device 100 works at a frequency of 2450 MHz, the peak gain of the antenna device 100 is 1.83 dBi, the efficiency of the antenna device 100 is 32.39%, and the average gain of the antenna device 100 is −4.9. When the antenna device 100 works at a frequency of 2500 MHz, the peak gain of the antenna device 100 is 0.74 dBi, the efficiency of the antenna device 100 is 26.20%, and the average gain of the antenna device 100 is −5.82 dBi. So the antenna device 100 has a better performance.

As described above, the circuit board 10 includes the flexible circuit board 11, and the metal cover 30 covers and adjacent to the antenna body 20 and the circuit board 10, the antenna body 20 is coupled with the metal cover 30 to motivate each other to make the antenna body 20 and the metal cover 30 respectively become the first radiating element and the second radiating element so as to reach the radiating purpose. As a result, the better radiating effect of the antenna device 100 is realized without cutting the metal cover 30 to decrease a manufacturing cost.

What is claimed is:

1. An antenna device applied in a headset device, comprising:
a circuit board including a flexible circuit board;
an antenna body mounted to and electrically connected with the flexible circuit board; and
a metal cover covering and adjacent to the antenna body and the circuit board,
wherein the antenna body is coupled with the metal cover to motivate each other to make the antenna body and the metal cover respectively become a first radiating element and a second radiating element.

2. The antenna device as claimed in claim 1, wherein a distance between the antenna body and the metal cover is within 4 mm.

3. The antenna device as claimed in claim 1, wherein the circuit board further includes a rigid circuit board electrically connected with the flexible circuit board.

4. The antenna device as claimed in claim 3, wherein the flexible circuit board has an antenna circuit, and the rigid circuit board has a ground circuit.

5. The antenna device as claimed in claim 3, wherein a front end of the flexible circuit board is connected to a rear end of the rigid circuit board, the flexible circuit board is folded over the rigid circuit board when the antenna device is assembled completely.

6. The antenna device as claimed in claim 3, wherein the antenna body has a long strip-shaped first section, a short strip-shaped second section, a long strip-shaped third section substantially parallel with the first section, and a feeding section, the first section and the third section extend substantially in a front-to-rear direction, the second section connected with rear ends of the first section and the third section, the feeding section connected with a front end of the first section.

7. The antenna device as claimed in claim 6, wherein the antenna body is a monopole antenna.

8. The antenna device as claimed in claim 6, wherein the antenna body further has a fourth section extended perpendicularly and towards the third section from a portion of the first section adjacent to the front end of the first section, and then perpendicularly bent frontward, the fourth section is electrically connected with a ground portion of the rigid circuit board, the antenna body is a PIFA type antenna.

9. The antenna device as claimed in claim 6, wherein the antenna body further has a fifth section, a front end of the third section extends frontward to the rigid circuit board to form the fifth section, the fifth section is electrically connected with a ground portion of the rigid circuit board, the antenna body is a loop type antenna.

10. The antenna device as claimed in claim 1, wherein a radiating frequency band of the first radiating element and the second radiating element is ranged between 2400 MHz and 2500 MHz.

11. The antenna device as claimed in claim 1, wherein the headset device is a Bluetooth headset.

12. The antenna device as claimed in claim 1, wherein the metal cover is integrally formed.
